(19) United States
(12) Patent Application Publication
(10) Pub. No.: US 2015/0153596 A1
(43) Pub. Date: Jun. 4, 2015

(54) DISPLAY PANEL AND METHOD FOR MANUFACTURING SAME

(71) Applicant: Sharp Kabushiki Kaisha, Osaka (JP)

(72) Inventors: Yuta Senokuchi, Osaka (JP); Tomoyuki Nagai, Osaka (JP); Noriyuki Ohashi, Osaka (JP); Shohichi Andoh, Osaka (JP)

(73) Assignee: Sharp Kabushiki Kaisha, Osaka (JP)

(21) Appl. No.: 14/405,217

(22) PCT Filed: Apr. 23, 2013
(86) PCT No.: PCT/JP2013/002748

§ 371 Date: Dec. 3, 2014

(30) Foreign Application Priority Data
Jun. 4, 2012 (JP) 2012-127268

(51) Int. Cl. G02F 1/1339; H05B 33/04; H05B 33/10; G02F 1/1333

(52) U.S. Cl. CPC G02F 1/1339; G02F 1/133308; H05B 33/04; H05B 33/10

(57) ABSTRACT

A liquid crystal display panel includes a frame region defined around a display area and constituted of a wide frame region defined on a terminal region side and narrow frame regions narrower than the wide frame region, and a sealing member provided in the frame region. The width of the sealing member in the narrow frame regions is less than the width of the sealing member in the wide frame region, and end faces of the sealing member in the corresponding narrow frame regions are disposed so as to be along respective end faces of the liquid crystal display panel in a plan view.

### TECHNICAL FIELD

The present invention relates to a display panel, such as a liquid crystal display panel in which a pair of substrates are stacked together with a prescribed gap therebetween and liquid crystal is sealed in the gap.

### BACKGROUND ART

In recent years, there has been demand for thinner and smaller display panels, such as liquid crystal display panels, following the rapid rise of mobile devices equipped with these display panels, such as notebooks computers and mobile phones.

A liquid crystal display panel typically includes a pair of substrates arranged facing each other (namely, a TFT (thin film transistor) substrate and a CF (color filter) substrate), a liquid crystal layer provided between these substrates, and a frame-shaped sealing member that adheres the substrates together and seals the liquid crystal between the substrates.

This type of liquid crystal display panel is used in mobile devices such as mobile phones, portable information terminal devices, portable gaming devices, and the like. There is particularly aggressive demand for the pixel areas in the liquid crystal display panel to be expanded, from the viewpoint of ease of carrying the mobile device and for the mobile device to be smaller and thinner. Accordingly, to achieve this type of pixel area expansion of the liquid crystal display panel, it is necessary for the portion outside the display area of the liquid crystal display panel (in other words, the frame region) to be able to be made as narrow as possible. This means that the frame region of the liquid crystal display panel must be made narrower.

To achieve a narrower frame region, the width of the sealing member disposed on the frame region needs to be reduced, but this decreases the adhesive area of the sealing member, thus lowering the adhesive strength and the bulk strength of the sealing member.

The most efficient method of forming the sealing member is for the sealing member to have the same width around the display area, which means that the portion of the sealing member on the wide frame region adjacent to the terminal region has the same width as the portion of the sealing member on the narrow frame regions.

The only member disposed in the terminal region, however, is the glass substrate that forms a portion of the TFT substrate. Therefore, if the sealing member is formed at the same width throughout, then when external stress is exerted on the terminal region and causes the portion of the substrate at the terminal region to warp, stress will be exerted on the portion of the sealing member in the wide frame region adjacent to the terminal region. This results in the base film of the sealing member peeling off.

If the width of the sealing member is reduced, the bulk strength thereof will be lowered. Thus, when the sealing member is hardened after the pair of substrates are bonded together, the sealed liquid crystal will leak through the sealing member to outside. This results in bubbles (voids) in the display area and causes display defects.

If the width of the sealing member is reduced, secondary stress exerted on the lower layer film of the sealing member will increase, thus causing the lower layer film on the TFT substrate side and the CF substrate side to peel off.

As a countermeasure, a liquid crystal display panel in which the adhesive strength of the sealing member is improved by providing a plurality of sealing members is proposed.

More specifically, a liquid crystal display panel is described as having sealing members that twice surround the display area on the frame region of the liquid crystal display panel. It is described that this type of configuration makes it possible to improve the adhesive strength of the sealing members and to improve the yield of manufacturing high-quality liquid crystal display panels (see Patent Document 1, for example).

### RELATED ART DOCUMENT

### Patent Document

Patent Document 1: Japanese Patent Application Laid-Open Publication No. 2003-295201

### SUMMARY OF THE INVENTION

### Problems to be Solved by the Invention

In general, however, the narrowness of the narrow frame region on the liquid crystal display panel makes it very difficult to form the sealing members twice surrounding the display area, as described in Patent Document 1 with respect to the liquid crystal display panel. Furthermore, if the sealing members are indeed formed to twice surround the display area, this leads to an increase in manufacturing steps.

The present invention was made in view of the above-mentioned problems, and aims at providing a display panel that can have a narrow frame region while avoiding a decrease in adhesive strength of the sealing member, and without increasing the number of manufacturing steps.

### Means for Solving the Problems

To achieve the above-mentioned aims, a display panel of the present invention includes: a first substrate; a second substrate facing the first substrate; a display element provided between the first substrate and the second substrate; a terminal region defined along one side of the first substrate; a display area where an image is displayed; a frame region defined around the display area, the frame region being constituted of a first frame region next to the terminal region and second frame regions that are narrower than the first frame region; and a sealing member disposed on the frame region and sandwiched between the first substrate and the second substrate to attach the first substrate to the second substrate, wherein a width of the sealing member in the second frame regions of the frame region is less than a width of the sealing member in the first frame region, and wherein end faces of the sealing member in the respective second frame regions are arranged so as to be aligned with corresponding end faces of the display panel in a plan view.

With this configuration, even if the wide sealing member is formed on the cutting line of the display panel in the second frame regions in the step of forming the sealing member, it is possible to cut the sealing member along this cutting line in the step of cutting to produce an optimum width, thereby making it possible to obtain a width of the sealing member that is sufficient to ensure adhesive strength in the second frame regions, which are narrow. Furthermore, an optimum width of the sealing member can also be obtained in the first frame region, which is wide, on the terminal region side in the step of forming the sealing member, after which this portion of the sealing member is not cut and can remain wider than the portion of the sealing member in the second frame regions. Accordingly, unlike in the conventional technology described above, this narrow-framed liquid crystal display panel can prevent a decrease in adhesive strength of the sealing member without increasing the number of manufacturing steps.

According to one aspect of the display panel of the present invention, the first substrate and the second substrate each further include a planarizing film disposed in the frame region on a side adjacent to the sealing member, the sealing member is formed on the planarizing films and further includes spacers disposed therein for defining a gap between the first substrate and the second substrate in the frame region, and a distance from the display area to the first frame region of the frame region is equal to a distance from the display area to the respective sealing member in the second frame regions of the frame region.

With this configuration, even if there is a difference in film thickness in the first frame region and the second frame regions, the heights of the sealing member on the display area side can be equal to each other, thus making it possible to prevent deviations in height of the sealing member in the first frame region and the second frame regions. Accordingly, the spacers can make the cell gap in the first frame region (the distance between the first substrate and the second substrate) match the cell gap in the second frame regions, and thus preventing variations in the cell gap in the entire display device.

According to one aspect of the display panel of the present invention, the width of the sealing member in the first frame region of the frame region is 0.4 mm to 1.6 mm and the width of the sealing member in the second frame regions of the frame region is 0.2 mm to 0.8 mm.

The display panel of the present invention has excellent characteristics, or namely, making it possible to provide a narrow-framed display panel that can prevent a reduction in adhesive strength of the sealing member without increasing the number of manufacturing steps. Accordingly, the present invention can be suitably used when the display panel has a display element that is a liquid crystal display element, or a display element that is an organic electroluminescent display element.

In the present invention, a method of manufacturing a first substrate, a second substrate facing the first substrate, a display element provided between the first substrate and the second substrate, a terminal region defined along one side of the first substrate, a display area where an image is displayed, a frame region defined around the display area, the frame region being constituted of a first frame region next to the terminal region and second frame regions that are narrower than the first frame region, and a sealing member disposed on the frame region and sandwiched between the first substrate and the second substrate to attach the first substrate to the second substrate, at least includes: fabricating a first mother substrate having a plurality of the first substrates formed thereon and a second mother substrate having a plurality of the second substrates formed thereon; forming the frame-shaped sealing member on each of the frame regions of the respective first substrates, the frame-shaped sealing member is formed so as to straddle respective cutting lines for the first substrate defined in the first mother substrate on the second frame regions on the respective first substrates; bonding the first mother substrate and the second mother substrate via the sealing members such that the cutting lines for the respective first substrates are aligned with cutting lines defined in the second mother substrate for separating the second substrates from the second mother substrate, and such that the sealing members respectively straddle the cutting lines for separating the second substrates, thereby forming a bonded member, and cutting the bonded member and each of the sealing members along the respective cutting lines for the first substrates and the respective cutting lines for the second substrates in the second frame regions so as to form sealing members that are narrower than the sealing members on the respective first frame regions.

With this configuration, even if the wide sealing member is formed on the cutting line of the display panel in the second frame regions in the step of forming the sealing member, it is possible to cut the sealing member along this cutting line in the step of cutting to produce an optimum width, thereby making it possible to obtain a width of the sealing member that is sufficient to ensure adhesive strength in the second frame regions, which are narrow. Furthermore, an optimum width of the sealing member can also be obtained in the first frame region, which is wide, on the terminal region side in the step of forming the sealing member, after which this portion of the sealing member is not cut and can remain wider than the portion of the sealing member in the second frame regions. Accordingly, unlike in the conventional technology described above, this narrow-framed liquid crystal display panel can prevent a decrease in adhesive strength of the sealing member without increasing the number of manufacturing steps.

According to the method of manufacturing a display panel of the present invention, in the step of fabricating the mother substrates, planarizing films are respectively formed on the first substrates and the second substrates, and in the step of forming the sealing members, each of the sealing members contains spacers for defining gaps between the respective first substrates and the second substrates in the frame region, and the sealing members are formed on the respective planarizing films such that a distance from the display area to the sealing member in the first frame region of the frame region is equal to a distance from the display area to the sealing member in each of the second frame regions of the frame region.

With this configuration, even if there is a difference in film thickness in the first frame region and the second frame regions, the heights of the sealing member on the display area side can be equal to each other, thus making it possible to prevent deviations in height of the sealing member in the first frame region and the second frame regions. Accordingly, the spacers can make the cell gap in the first frame region (the distance between the first substrate and the second substrate) match the cell gap in the second frame regions, and thus preventing variations in the cell gap in the entire display device.

According to the method of manufacturing a display panel of the present invention, in the step of cutting, a super steel wheel is used to cut the bonded member and the sealing members.

The display panel of the present invention has excellent characteristics, or namely, making it possible to provide a narrow-framed display panel that can prevent a reduction in adhesive strength of the sealing member without increasing the number of manufacturing steps. Accordingly, the method of manufacturing a display panel of the present invention can be applied when the display element is a liquid crystal display element, or the when the display element is an organic electroluminescent display element.

### Effects of the Invention

According to the present invention, it is possible to provide a display panel that that can have a narrow frame region while avoiding a decrease in adhesive strength of the sealing member, and without increasing the number of manufacturing steps.

### BRIEF DESCRIPTION OF THE DRAWINGS

FIG. 1 is a plan view of a liquid crystal display panel according to Embodiment 1 of the present invention.

FIG. 2 is a cross-sectional view of FIG. 1 along A-A.

FIG. 3 is a cross-sectional view of FIG. 1 along B-B.

FIG. 4 is a plan view of a TFT mother substrate in the liquid crystal display panel according to Embodiment 1 of the present invention.

FIG. 5 is a plan view of a CF mother substrate in the liquid crystal display panel according to Embodiment 1 of the present invention.

FIG. 6 is a plan view for explaining a method of manufacturing a sealing member of the liquid crystal display panel according to Embodiment 1 of the present invention.

FIG. 7 is a plan view of a bonded member, which is the TFT mother substrate and the CF mother substrate bonded together.

FIG. 8 is a plan view of a liquid crystal display panel according to Embodiment 2 of the present invention.

FIG. 9 is a partial cross-sectional view of the liquid crystal display panel according to Embodiment 2 of the present invention.

FIG. 10 is a partial cross-sectional view of the liquid crystal display panel according to Embodiment 2 of the present invention.

FIG. 11 is a plan view of an organic EL display device according to a modification example.

FIG. 12 is a cross-sectional view of FIG. 11 along C-C.

### DETAILED DESCRIPTION OF EMBODIMENTS

Embodiments of the present invention will be described in detail below with reference to drawings. The present invention is not limited to the embodiments below.

### Embodiment 1

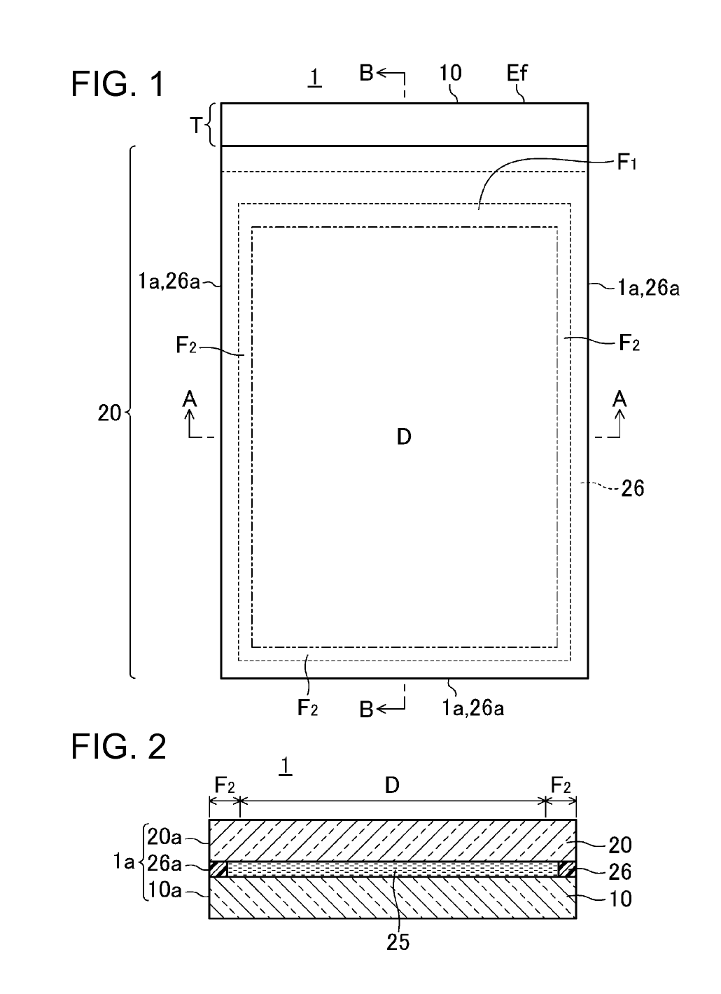

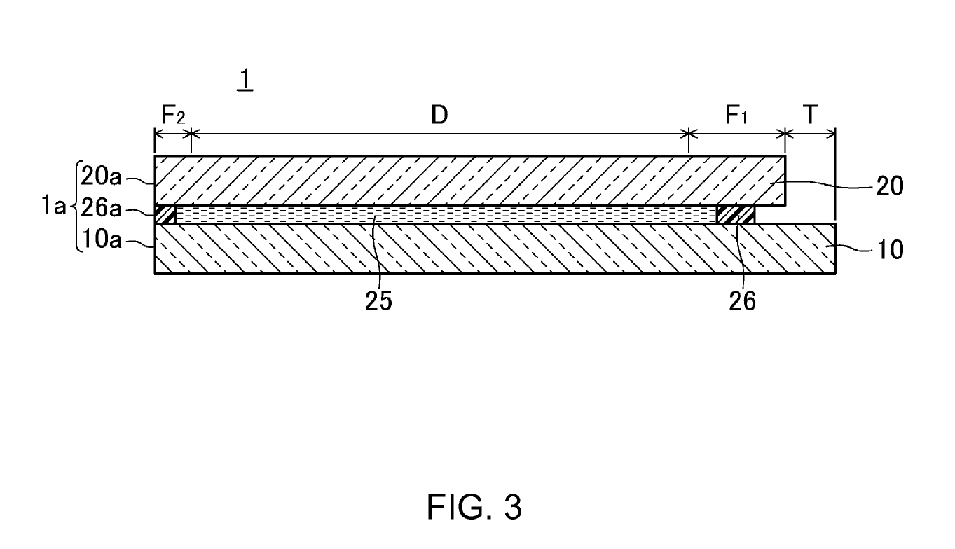

FIG. 1 is a plan view of a liquid crystal display panel according to Embodiment 1 of the present invention, and FIG. 2 is a cross-sectional view of FIG. 1 along A-A. FIG. 3 is a cross-sectional view of FIG. 1 along B-B.

As shown in FIGS. 1 to 3, a liquid crystal display panel 1 includes a TFT substrate 10, which is a first substrate, a CF substrate 20, which is a second substrate facing the TFT substrate 10, a liquid crystal layer 25 provided between the TFT substrate 10 and the CF substrate 20, and a frame-shaped sealing member 26 for adhering the TFT substrate 10 to the CF substrate 20 and sealing the liquid crystal layer 25 therebetween.

This sealing member 26 is formed so as to surround the liquid crystal layer 25, and the TFT substrate 10 and the CF substrate 20 are bonded to each other through this sealing member 26.

As shown in FIGS. 1 and 3, in the liquid crystal display panel 1, the TFT substrate 10 protrudes outward more than the CF substrate 20, and this protruding area is where a plurality of wiring lines used for display such as gate lines and source lines are drawn out and where a terminal region T is formed, as described later.

The terminal region T of the liquid crystal display panel 1 is defined along one side (a top Ef) of the TFT substrate 10, and the terminal region T has a so-called “three-side-free structure,” in which the terminal region is disposed only on the one side mentioned above.

In the liquid crystal display panel 1, a display area D, which is where image display is performed, is defined by an area where the TFT substrate 10 and the CF substrate 20 overlap. A plurality of pixels, which are the smallest units of an image, are arranged in a matrix in the display area D.

A four-sided frame region, which is where the sealing member 26 is disposed, is defined around the display area D, and as shown in FIGS. 1 to 3, one side of this frame region is a wide frame region F₁ defined on the terminal region T side, and the other three sides are narrow frame regions F₂, which each have a width that is less than that of the wide frame region F₁.

The TFT substrate 10 includes a plurality of gate lines (not shown) arranged so as to extend in parallel to each other on an insulating substrate such as a glass substrate or a plastic substrate, a gate insulating film (not shown) covering the gate lines, and a plurality of source lines (not shown) arranged on the gate insulating film so as to extend in parallel to each other in a direction intersecting the respective gate lines, for example. The TFT substrate 10 also includes a plurality of TFTs (not shown), with one TFT being disposed at each intersection of the respective gate lines and source lines (in other words, one TFT for each pixel), a planarizing film covering the TFTs and source lines, a plurality of pixel electrodes (not shown) arranged in a matrix on the planarizing film and connected to the respective TFTs, and an alignment film (not shown) covering the pixel electrodes.

The CF substrate 20 includes a frame-shaped black matrix (not shown) disposed on an insulating substrate such as a glass substrate or plastic substrate in a grid pattern as a light-shielding member, and a color filter (not shown) having red portions, green portions, blue portions, or the like arranged so as to correspond to the black matrix grid, for example. The CF substrate 20 also includes a planarizing film (not shown) covering the black matrix and the color filter, a common electrode (not shown) disposed on the planarizing film, columnar photospacers (not shown) provided on the common electrode, and an alignment film (not shown) disposed on the common electrode.

The liquid crystal layer 25 is made of a nematic liquid crystal material that has electrooptical characteristics, for example.

The configuration of the liquid crystal display panel 1 of the present embodiment has a liquid crystal display element constituted of pixel electrodes, the liquid crystal layer 25 formed on the pixel electrodes, and a common electrode formed on the liquid crystal layer 25.

As shown in FIG. 1, the sealing member 26 is a rectangular shape that surrounds the entirety of the display area D. The width of the sealing member 26 has no particular limitations, but can be set to 0.2 mm to 1.6 mm, for example.

The width of the sealing member 26 in the wide frame region F₁ can be set to 0.4 mm to 1.6 mm, and the width of the narrow frame regions F₂ can be set to 0.2 mm to 0.8 mm.

For the sealing material constituting this sealing member 26, it possible to appropriately use an ultraviolet curable resin such as an acrylic resin, urethane resin, polyester resin, and epoxy resin, or a light-curable resin such as a visible light curable resin that hardens when illuminated by visible light, such as an acrylic resin, methacrylic resin, epoxy resin, and silicone resin, for example. These resins may be used individually or two or more types of these resins may be used together simultaneously.

The liquid crystal display panel 1 has one pixel for each pixel electrode, and a prescribed amount of voltage is applied to the liquid crystal layer 25 at the respective pixels. The liquid crystal display panel 1 is configured such that the transmittance of light from the backlight is adjusted by changing the orientation state of the liquid crystal molecules by varying the amount of voltage applied to the liquid crystal layer 25, thereby causing an image to be displayed, for example.

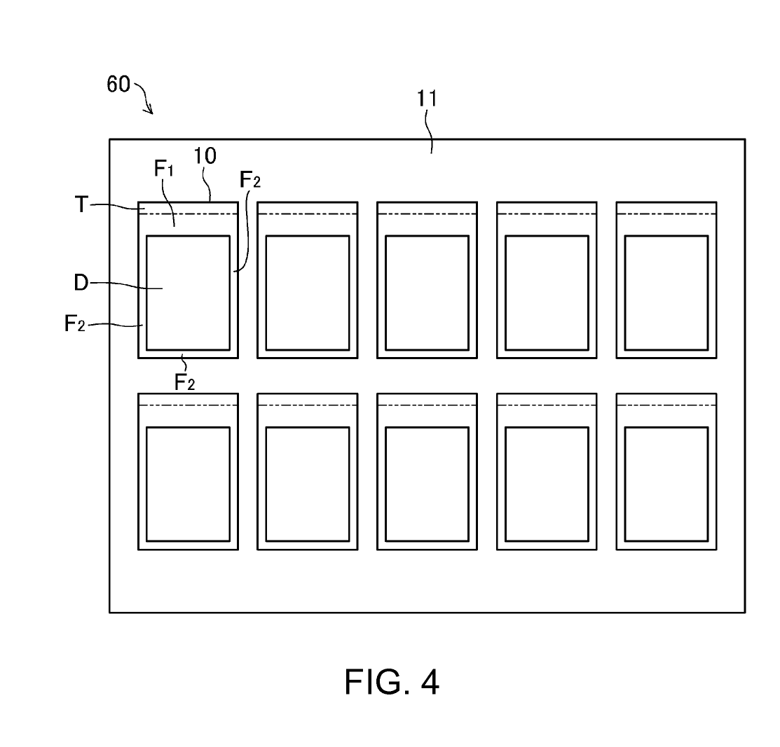

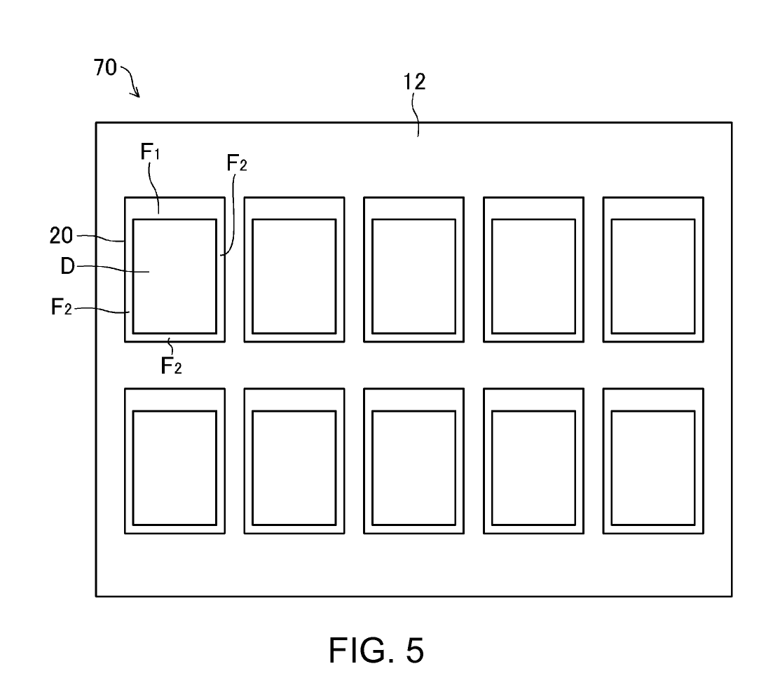

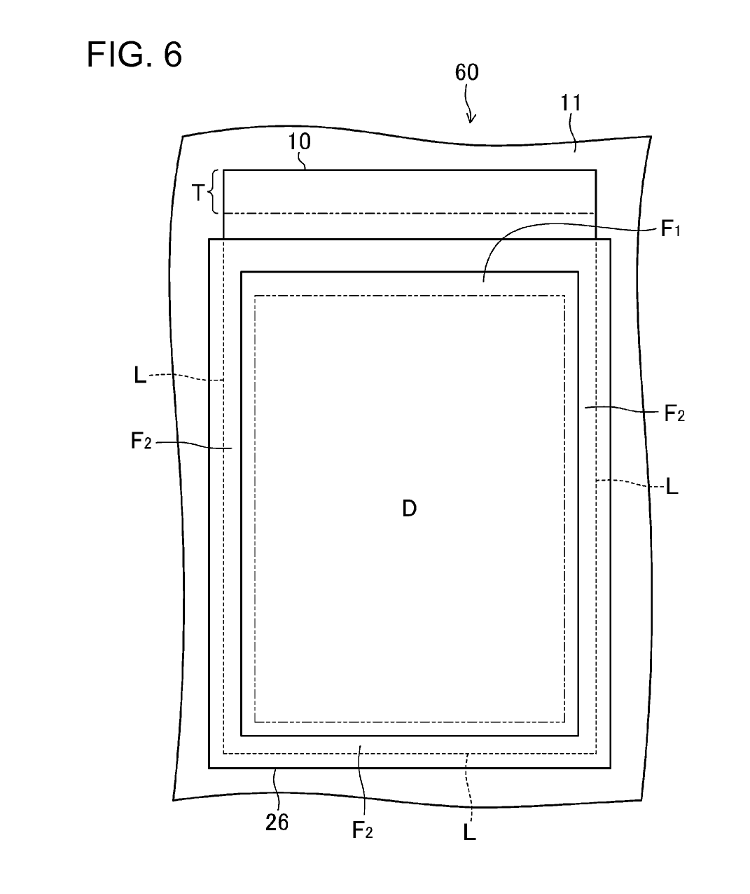

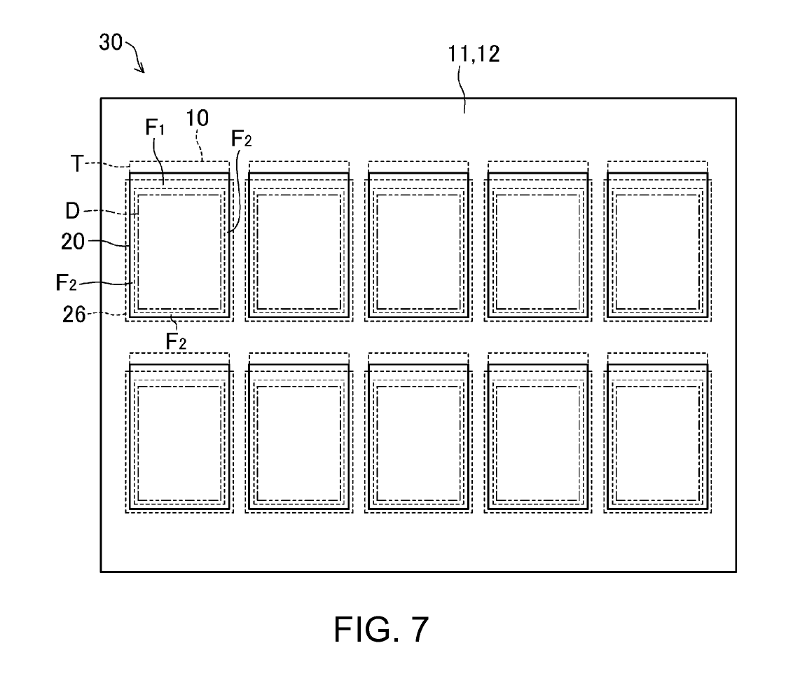

Next, one example of a method of manufacturing the liquid crystal display panel of the present embodiment will be explained. FIG. 4 is a plan view of a TFT mother substrate of the liquid crystal display panel according to Embodiment 1 of the present invention, and FIG. 5 is a plan view of the CF mother substrate of the liquid crystal display panel according to Embodiment 1 of the present invention. FIG. 6 is a plan view for explaining a method of manufacturing the sealing member of the liquid crystal display panel according to Embodiment 1 of the present invention, and FIG. 7 is a plan view of a bonded member, which is the TFT mother substrate and the CF mother substrate bonded together. The method of manufacturing in the present embodiment includes fabricating the mother substrates, forming the sealing member, injecting liquid crystal material, bonding to form a bonded member, and cutting.

<Fabricating Mother Substrates>

A TFT mother substrate 60 shown in FIG. 4 is fabricated by patterning TFTs, pixel electrodes, and the like on a substrate body 11 made of non-alkali glass, forming a plurality of active element layers that respectively constitute the display areas D, and forming an alignment film on the surface, thereby defining the plurality of display areas D and terminal regions T in a matrix, for example. In the present embodiment, as shown in FIG. 4, 10 of the TFT substrates 10 are fabricated from one mother substrate 60.

A CF mother substrate 70 shown in FIG. 5 is fabricated by patterning black matrices, color filters, common electrodes, and the like on a substrate body 12 made of non-alkali glass, forming a plurality of CF element layers that respectively constitute the display areas D, and forming an alignment film on the surface, thereby defining the plurality of display areas D in a matrix, for example

The black matrix is formed of a metal material such as Ta (tantalum), Cr (chromium), Mo (molybdenum), Ni (nickel), Ti (titanium), Cu (copper), or Al (aluminum), a resin material that has black pigment such as carbon dispersed therein, or a resin material or the like having a plurality of transmissive colored portions stacked together. In the present embodiment, as shown in FIG. 5, 10 of the CF substrates 20 are fabricated from one mother substrate 70.

<Forming Sealing Member>

Next, a dispenser is used to draw the sealing member 26 in a frame shape having a width of 1 mm, for example, on the four sides of the frame region on the respective TFT substrates 10. As shown in FIG. 6, the sealing member 26 is formed in a frame shape along the four sides of the TFT substrate 10, but at this time, the frame member 26 straddles a cutting line L of the TFT substrate 10, described later in the cutting process, and is formed on the narrow frame regions F₂ of the TFT substrate 10 and the substrate body 11. Accordingly, it is possible to form the sealing member 26 with a large thickness without being restrained by the width of the narrow frame regions F₂.

In this step, the dispenser coats unhardened sealing material onto the TFT substrate 10, during which the movement speed of the dispenser can be adjusted to control the discharge rate of the sealing material (in other words, to control the width of the sealing member 26).

Namely, increasing the movement speed of the dispenser (i.e., increasing the drawing speed) makes it possible to lower the discharge rate of the sealing material, and decreasing the movement speed of the dispenser (i.e., decreasing the movement speed) makes it possible to raise the discharge rate of the sealing material.

<Injecting Liquid Crystal>

Next, in a vacuum, liquid crystal is dripped inside the respective display areas D (namely, inside the respective sealing members 26) of the TFT substrates 10 on the mother substrate 60. The dripping of the liquid crystal material is performed by a dripping device having a liquid crystal dripping function dripping liquid crystal material over the entire substrate while moving, for example.

<Bonding to Form Bonded Member>

First, the TFT substrate 10 having the liquid crystal dripped therein in the step of injecting liquid crystal and the CF substrate 20 are bonded together in a depressurized environment such that the display areas D of each respectively overlap. Thereafter, the bonded member is exposed to the atmosphere to diffuse the liquid crystal material and form the liquid crystal layer 25, and a heating and pressurizing treatment is performed under prescribed parameters (pressure at 2.5 MPa and temperature at 150° C. for 30 minutes, for example) to adhere the sealing member 26 to the CF substrate 20 and, as shown in FIG. 7, to bond the TFT substrates 10 to the respective CF substrates 20 through the corresponding sealing members 26.

At this time, as shown in FIG. 7, the sealing members 26 are arranged on the narrow frame regions F₂ of the respective CF substrates 20 and the substrate body 12 so as to straddle the cutting line L of the respective CF substrates 20 for the cutting process, described later.

Next, the frame regions of the bonded member are illuminated with UV light to temporarily harden the sealing members 26 and then heated to permanently harden the sealing members 26, thereby bonding the mother substrate 60 to the mother substrate 70 and forming the bonded member 30 having the liquid crystal layer 25 sealed therebetween, as shown in FIG. 7.

<Cutting>

Next, the edge of a super steel wheel contacts the front surface and rear surface of the bonded member 30 and cuts the bonded member 30 around each of the display areas D along the cutting line L described above, thereby manufacturing the liquid crystal display panel 1 shown in FIGS. 1 to 3.

At this time, the portions of the sealing member 26 located on the substrate bodies 11 and 12 from the cutting line L and outwards on the narrow frame regions F₂ (or namely, opposite to the display area D side) are simultaneously cut along the cutting line L, but the wide frame region F₁ on the terminal region T side is not cut. This makes the sealing member 26 have a narrower width than the portions thereof in the wide frame region F₁, thereby manufacturing the liquid crystal display panel 1, which has end faces 1a (namely, end faces 10a of the TFT substrate 10 and end faces 20a of the CF substrate 20) on the narrow frame regions F₂ shown in FIGS. 1 to 3 that are on the same plane as end faces 26 of the sealing member 26 (in other words, the end face 1a of the liquid crystal display panel 1 is on the same plan as the end faces 26a of the sealing member 26, and there is no level difference between the end faces 1a of the liquid crystal display panel 1 and the end faces 26a of the sealing member 26).

More specifically, the manufactured liquid crystal display panel 1 has the end faces 26a of the sealing member 26 arranged in the narrow frame regions F₂ so as to be along the respective end faces 1a of the liquid crystal display panel 1 in a plan view.

Accordingly, as shown in FIG. 1, the sealing member 26 can be formed in the narrow frame regions F₂ with a width that is sufficient to ensure adhesive strength.

The sealing member 26 is not cut in the wide frame region F₁ on the terminal region T side, thereby making it possible to form the sealing member 26 at a significantly large width.

With this type of configuration, in the present embodiment, even if the wide sealing member 26 is formed on the cutting line L of the liquid crystal display panel 1 in the step of forming the sealing member, cutting the sealing member 26 along this cutting line L makes it possible for the sealing member 26 to have a sufficient width to ensure adhesive strength on the narrow frame regions F₂. Therefore, the sealing member 26 is formed at the optimum width on the wide frame region F₁ on the terminal region T side in the step of forming the sealing member, after which the sealing member 26 is not cut and can be made thicker. Accordingly, unlike in the conventional technology described above, the liquid crystal display panel 1 can prevent a decrease in adhesive strength of the sealing member 26 without increasing the number of manufacturing steps.

The width of the sealing member 26 in the narrow frame regions F₂ can be set to 0.6 mm, for example.

The super steel wheel used for cutting is a disc-shaped cutting blade made of a cemented carbide such as tungsten carbide, for example, and the side face of the disc protrudes in a tapered fashion towards the center of the thickness direction thereof. The super steel wheel can have a protrusion formed at the tapered tip thereof.

### Embodiment 2

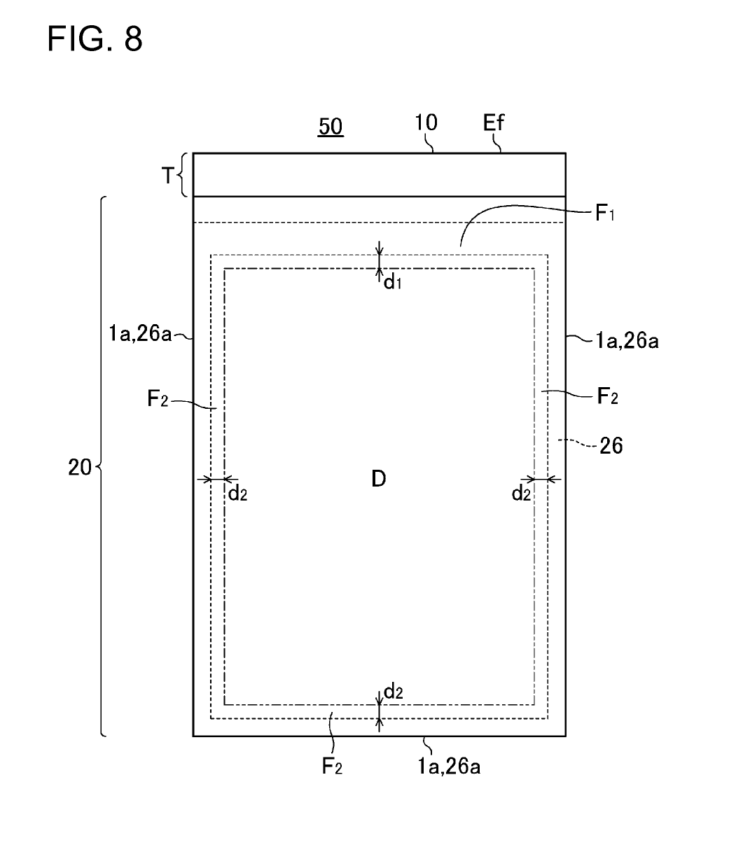

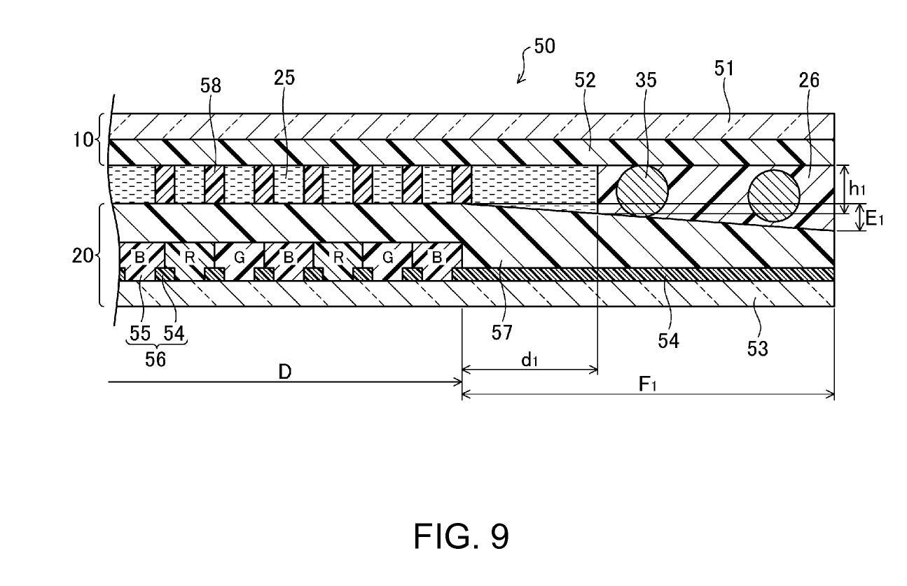

Next, Embodiment 2 of the present invention will be described. FIG. 8 is a plan view of a liquid crystal display panel according to Embodiment 2 of the present invention, and FIG. 9 is a partial cross-sectional view of the liquid crystal display panel according to Embodiment 2 of the present invention. In the present embodiment, constituent portions similar to those of Embodiment 1 are assigned the same reference characters and descriptions thereof are omitted. Furthermore, the configuration of the entire liquid crystal display device and the method of manufacturing thereof are similar to what was described in Embodiment 1 above, and thus, detailed descriptions thereof are omitted here.

As shown in FIG. 8, the present embodiment is characterized in that distances d₁ and d₂ from a display area D to a sealing member 26 in the respective frame regions (a wide frame region F₁ and narrow frame regions F₂) are equal to each other (d₁=d₂).

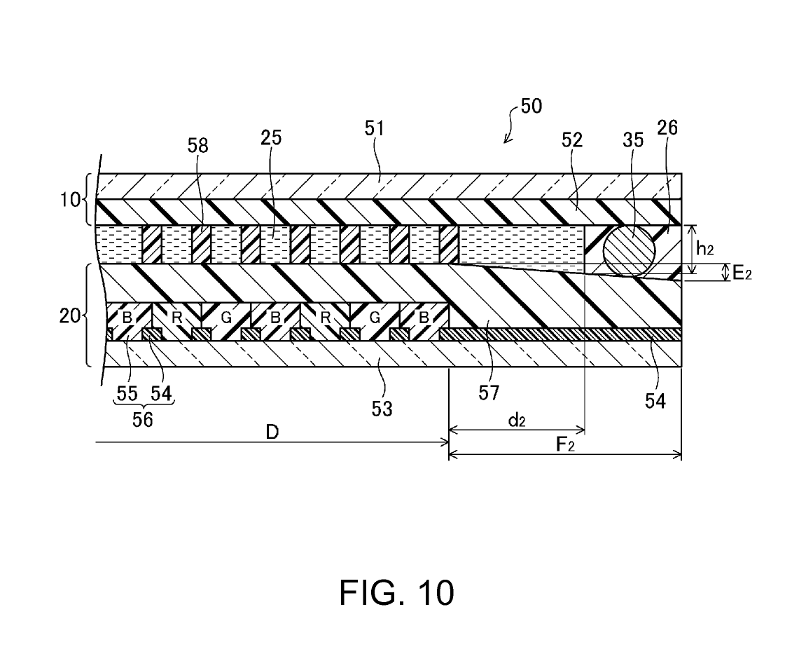

As shown in FIGS. 9 and 10, a planarizing film 52 is provided on an insulating substrate 51 such as a glass substrate in a TFT substrate 10 of a liquid crystal display panel 50 of the present embodiment (in other words, the planarizing film 52 is disposed on the sealing member 26 side of the TFT substrate 10).

An insulating substrate 53 such as a glass substrate in a CF substrate 20 has provided thereon (on the sealing member 26 side of the CF substrate 20): a black matrix 54; a color filter 56 having colored portions 55 such as red portions R, green portions G, and blue portions B disposed so as to respectively correspond to the grid pattern of the black matrix 54; a planarizing film 57 covering the black matrix 54 and the color filter 56; and columnar photospacers 58 provided on the planarizing film 57.

As shown in FIGS. 9 and 10, spacers 35 for regulating the cell gap (the distance between the TFT substrate 10 and the CF substrate 20) are provided in the sealing member 26 in the frame region (the wide frame region F₁ and the narrow frame regions F₂). A liquid crystal layer 25 is provided between the TFT substrate 10 and the CF substrate 20.

As described above, the planarizing films 52 and 57 are respectively provided on the TFT substrate 10 and the CF substrate 20, and are generally formed by spin coating or slit coating.

As shown in FIGS. 9 and 10, the multilayer structure of the frame region (the wide frame region F₁ and the narrow frame regions F₂) only having the black matrix 54 on the CF substrate 20 is thinner than the multilayer structure of the display area D having the color filter 56.

Accordingly, in the display area D, the base is thick and the planarizing film is thin, and thus there is less material (for forming the planarizing film 57) flowing outward due to centrifugal force when forming the planarizing film 57 by spin coating, for example. This contrasts with the frame region (the wide frame region F₁ and the narrow frame regions F₂) where the base is thin and the planarizing film 57 is thick, which means that more material flows outward due to centrifugal force.

Thus, as shown in FIGS. 9 and 10, the planarizing film 57 is progressively thinner farther away from the display area D in the frame region (the wide frame region F₁ and the narrow frame regions F₂), which causes a film thickness difference E₁ and E₂ to occur in the planarizing film 57.

As a result, there are problems in which the frame region (wide frame region F₁ and narrow frame regions F₂) has variation in the height of the sealing member 26; it is difficult to regulate the cell gap with the spacers 35; and variation occurs in the cell gap.

As a countermeasure, in the present embodiment, as shown in FIGS. 8 to 10, the sealing member 26 is formed such that the distance d₁ from the display area D to the wide frame region F₁ is equal to the distance d₂ from the display area D to the sealing member 26 on the narrow frame regions F₂, thereby making it possible to set heights h₁ and h₂ of the sealing member 26 on the display area D side equal to each other even if there is a film thickness difference E₁ and E₂ of the planarizing film 57 in the wide frame region F₁ and the narrow frame regions F₂.

Accordingly, the spacers 35 can prevent the deviations in height of the sealing member 26 in the wide frame region F₁ and the narrow frame regions F₂, and can prevent the occurrence of variation in the cell gap in the entire liquid crystal display panel 50 due to the cell gap in the wide frame region F₁ being equal to the cell gap in the narrow frame regions F₂.

The embodiments above may be modified in the following manner.

In the respective embodiments above, an example was described in which the liquid crystal display panel 1 was the display panel, but the present invention can also be applied to other display panels, such as an organic EL display panel, for example.

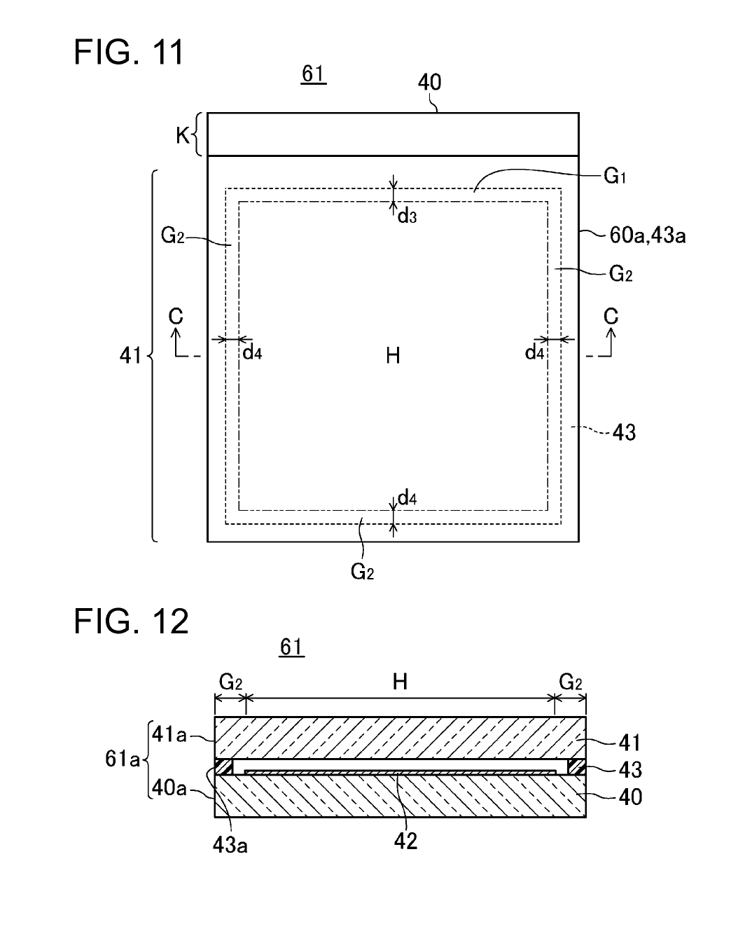

As shown in FIGS. 11 and 12, the present invention can be applied to an organic EL display panel 61 having a circuit substrate 40, which is a first substrate, a sealing substrate 41, which is a second substrate that faces the circuit substrate 40, an organic EL display element 42 formed on the circuit substrate 40 and disposed between the circuit substrate 40 and the sealing substrate 41, and a sealing member 43 disposed between the circuit substrate 40 and the sealing substrate 41 for bonding the circuit substrate 40 to the sealing substrate 41 so as to seal the organic EL display element 42, for example.

This sealing member 43 is formed in a frame shape that surrounds the organic EL display element 42, and the circuit substrate 40 and the sealing substrate 41 are bonded to each other through this sealing member 43.

As shown in FIGS. 11 and 12, the circuit substrate 40 has a display area H that has the organic EL display element 42 provided therein and that is surrounded by the sealing member 43.

A four-sided frame region where the sealing member 43 is provided is defined around the display area H, and as shown in FIGS. 11 and 12, one side of this frame region is a wide frame region G₁ defined on a terminal region K side, and the other three sides are narrow frame regions G₂ that have a width that is less than that of the wide frame region G₁.

In a manner similar to the liquid crystal display panel 1 described above, the organic EL display panel 61 shown in FIGS. 11 and 12 is configured such that end faces 61a thereof in the narrow frame regions G₂ are on the same plane as end faces 43a of the sealing member 43 (in other words, end faces 40a of the circuit substrate 40 and the end faces 41a of the sealing substrate 41). More specifically, in the narrow frame regions G₂, the end faces 43a of the sealing member 43 are disposed so as to be along the end faces 61a of the organic EL display panel 61 in a plan view.

When manufacturing the organic EL display panel 61, in a manner similar to the liquid crystal display panel 1 described above, the sealing member 43 is formed in a frame shape along the four sides of the circuit substrate 40 in the step of forming the sealing member, and the sealing member 43 is formed on the narrow frame regions G₂ of the circuit substrate 40 by straddling the cutting line of the circuit substrate in the step of cutting.

Next, in the step of bonding to form the bonded member, the circuit substrate 40 having the organic EL display element 42 formed thereon is bonded to the sealing substrate 41 in a depressurized environment such that the display regions H of each overlap, and the sealing member 43 is disposed in the narrow frame regions G₂ of the sealing substrate 41 so as to straddle the cutting line of the sealing substrate 41 in the step of cutting.

In the step of cutting, the sealing member 43 formed straddling the cutting line on the substrate bodies outside the narrow frame regions G₂ (or namely, opposite to the display area H side) are simultaneously cut along with the bonded member on the three narrow frame regions G₂, but not the wide frame region G₁ on the terminal region K side, thereby manufacturing the organic EL display panel 61 shown in FIGS. 11 and 12.

Accordingly, as shown in FIG. 11, the sealing member 43 can be formed having a sufficient width to ensure adhesive strength in the narrow frame regions G₂, and the sealing member 43 is not cut in the wide frame region G₁ on the terminal region K side, thereby making it possible to form the sealing member 43 at a large width. As a result, in a manner similar to the liquid crystal display panel 1, the narrow-framed organic EL display panel 61 can prevent a reduction in adhesive strength of the sealing member 43 without increasing the number of manufacturing steps.

In a manner similar to the liquid crystal display panel 50 described above, spacers (made of SiO₂ (silicon oxide), for example) for regulating the gap between the circuit substrate 40 and the sealing substrate 41 may be provided in the sealing member 43, and a planarizing film may be provided on the sealing member 43 side of the circuit substrate 40 and the sealing substrate 41. Furthermore, as shown in FIG. 11, the sealing member 43 may be formed such that a distance d₃ from the display area H to the sealing member 43 in the wide frame region G₁ may equal the distance d₄ from the display area H to the sealing member 43 in the respective narrow frame regions G₂.

In the respective embodiments above, the portions of the sealing member 26 formed on the substrate bodies 11 and 12 outside the narrow frame regions F₂ and straddling the cutting line L are cut on the corresponding three sides of the narrow frame regions F₂, thereby manufacturing the liquid crystal display panel 1 in which the end faces 1a thereof are on the same plane as the end faces 26a of the sealing member 26, but a configuration may be used in which the portions of the sealing member 26 formed on the substrate bodies 11 and 12 outside the narrow frame regions F₂ straddling the cutting line L are cut on one side or two sides of the narrow frame regions out of the three sides of the narrow frame regions F₂.

In other words, in the present invention, the portion of the sealing member 26 formed on the substrate bodies 11 and 12 outside the narrow frame regions F₂ straddling the cutting line L can be cut on at least one of the narrow frame regions F₂ defined around the display area D to manufacture the liquid crystal display panel 1 having the end faces 1a thereof that are on the same plane as the end faces 26a of the sealing member 26.

In the respective embodiments above, an example was described in which the sealing member 26 is formed on the four sides of the frame region of the TFT substrate 10, but the sealing member 26 may be formed on the frame region of the CF substrate 20.

The respective widths of the narrow frame regions of the three sides described above may be the same size or may be different sizes.

### INDUSTRIAL APPLICABILITY

As described above, the present invention is applicable to a display panel such as a liquid crystal display panel in which a pair of substrates overlap each other with a prescribed gap therebetween and then are bonded to each other via a sealing member, and a method of manufacturing this display panel.

### DESCRIPTION OF REFERENCE CHARACTERS

1 liquid crystal display panel (display panel)
1a end face of liquid crystal display panel
10 TFT substrate (first substrate)
10a end face of TFT substrate
11 substrate body
12 substrate body
20 CF substrate (second substrate)
20a end face of CF substrate
25 liquid crystal layer (display medium layer)
26 sealing member
26a end face of sealing member
30 bonded member
35 spacer
40 circuit substrate (first substrate)
40a end face of circuit substrate
41 sealing substrate (second substrate)
41a end face of sealing substrate
42 organic EL display element
43 sealing member
43a end face of sealing member
50 liquid crystal display panel
51 insulating substrate
52 planarizing film
53 insulating substrate
54 black matrix
55 colored portion
56 color filter
57 planarizing film
58 photospacer
60 mother substrate (first mother substrate)
61 organic EL display panel (display panel)
61a end face of organic EL display panel
70 mother substrate (second mother substrate)
D display area
d₁ distance between display area and sealing member in wide frame region
d₂ distance between display area and sealing member in narrow frame region
d₃ distance between display area and sealing member in wide frame region
d₄ distance between display area and sealing member in narrow frame region
E₁ difference in film thickness of planarizing film
E₂ difference in film thickness of planarizing film
F₁ wide frame region (first frame region)
F₂ narrow frame region (second frame region)
G₁ wide frame region (first frame region)
G₂ narrow frame region (second frame region)
T terminal region

1. A display panel, comprising:
a first substrate;
a second substrate facing the first substrate;
a display element provided between the first substrate and the second substrate;
a terminal region defined along one side of the first substrate;
a display area where an image is displayed;
a frame region defined around the display area, said frame region being constituted of a first region next to the terminal region and second regions that are narrower than the first region; and
a frame-shaped sealing member disposed on said frame region and sandwiched between the first substrate and the second substrate to attach the first substrate to the second substrate,
wherein a width of the frame-shaped sealing member in the second regions of the frame region is less than a width of the frame-shaped sealing member in the first region, and
wherein outer side faces of the frame-shaped sealing member in the respective second regions are arranged so as to be aligned with corresponding edges of the display panel in a plan view.

2. The display panel according to claim 1,
wherein the first substrate and the second substrate each further include a planarizing film disposed in the frame region on a side adjacent to the frame-shaped sealing member,
wherein the frame-shaped sealing member is formed on the planarizing films and further includes spacers disposed therein for defining a gap between the first substrate and the second substrate in the frame region, and
wherein a distance from the display area to the frame-shaped sealing member in the first region of the frame region is equal to a distance from the display area to the respective frame-shaped sealing member in the second regions of the frame region.

3. The display panel according to claim 1, wherein the width of the frame-shaped sealing member in the first region of the frame region is 0.4 mm to 1.6 mm and the width of the frame-shaped sealing member in the second regions of the frame region is 0.2 mm to 0.8 mm.

4. The display panel according to claim 1, wherein the display element is a liquid crystal display element.

5. The display panel according to claim 1, wherein the display element is an organic electroluminescent display element.

6. A method of manufacturing a plurality of display panels each having a first substrate, a second substrate facing the first substrate, a display element provided between the first substrate and the second substrate, a terminal region defined along one side of the first substrate, a display area where an image is displayed, a frame region defined around the display area, said frame region being constituted of a first region next to the terminal region and second regions that are narrower than the first region, and a frame-shaped sealing member disposed on said frame region and sandwiched between the first substrate and the second substrate to attach the first substrate to the second substrate, the method comprising:
fabricating a first mother substrate having a plurality of the first substrates formed thereon and a second mother substrate having a plurality of the second substrates formed thereon;
forming the frame-shaped sealing member on each of the frame regions of the respective first substrates, wherein, in the second regions of the frame region, said frame-shaped sealing member is formed so as to straddle respective cutting lines for separating the first substrate from the first mother substrate;
bonding the first mother substrate and the second mother substrate via the frame-shaped sealing members such that the cutting lines for the respective first substrates are aligned with cutting lines defined in the second mother substrate for separating the second substrates from the second mother substrate, and such that the sealing members respectively straddle the cutting lines for separating the second substrates, thereby forming a bonded member; and
cutting the bonded member and each of the sealing members along the respective cutting lines for the first substrates and the respective cutting lines for the second substrates in the second frame regions such that a width of each of the sealing members in the respective second regions of the frame region is less than width of each of the sealing members in the respective first regions.

7. The method of manufacturing a display panel according to claim 6,
wherein, in the step of fabricating the mother substrates, planarizing films are respectively formed on the first substrates and the second substrates, and
wherein, in the step of forming the frame-shaped sealing members, each of the frame-shaped sealing members contains spacers for defining gaps between the respective first substrates and the second substrates in the frame region, and the frame-shaped sealing members are formed on the respective planarizing films such that a distance from the display area to the sealing member in the first region of the frame region is equal to a distance from the display area to the frame-shaped sealing member in each of the second regions of the frame region.

8. The method of manufacturing a display panel according to claim 6,
wherein, in the step of cutting, a super steel wheel is used to cut the bonded member and the frame-shaped sealing members.

9. The method of manufacturing a display panel according to claim 6, wherein the display element is a liquid crystal display element.

10. The method of manufacturing a display panel according to claim 6, wherein the display element is an organic electroluminescent display element.
